(19) United States
(12) Patent Application Publication
(10) Pub. No.: US 2026/0338997 A1
(43) Pub. Date: Oct. 29, 2026

(54) METALENS, MANUFACTURING METHOD THEREOF, AND OPTICAL APPARATUS

(71) Applicant: Tamron Co., Ltd., Saitama (JP)

(72) Inventor: Takayuki NODA, Saitama (JP)

(73) Assignee: Tamron Co., Ltd., Saitama (JP)

(21) Appl. No.: 19/567,263

(22) Filed: Mar. 16, 2026

(30) Foreign Application Priority Data
Apr. 25, 2025 (JP) 2025-073641

(51) Int. Cl. G02B 3/08

(52) U.S. Cl. CPC G02B 3/08

(57) ABSTRACT

A metalens includes a metasurface formed only on one principal surface of a substrate. The metasurface is configured by arranging pillars such that positions of the pillars in a continuous region, with reference to a peak point of phase in an X direction, satisfy a specific formula.

### CROSS-REFERENCE TO RELATED APPLICATIONS

This application is based on and claims the benefit of priority from Japanese Patent Application No. 2025-073641, filed on Apr. 25, 2025, the entire contents of which are incorporated herein by reference.

### BACKGROUND OF THE INVENTION

### Technical Field

The present invention relates to a metalens, manufacturing method thereof, and an optical apparatus.

### Related Art

In an optical instrument such as a Raman probe, a lens having refraction and focusing is used in accordance with a desired function of the apparatus. Such a lens is required to be miniaturized, and a metalens is known as a lens capable of supporting such miniaturization.

As a metalens having refraction and focusing, a metalens is known which has metasurfaces on both surfaces of an optically transparent substrate, refracts light incident on one principal surface from the other principal surface, and also focuses the light and emits the light (see, for example, WO 2022/103599 A). Further, as the metalens, there is known a lens that is composed of an optically transparent biomaterial, has a metasurface, and is configured to change light modulation characteristics in accordance with changes in the environment (see, for example, US 2021/0275294 A). Furthermore, as the metalens, there is known a metalens used in combination with an optical member that reflects or absorbs a part of diffracted light generated in the metalens (see, for example, JP 2024-12218 A).

However, the conventional techniques as described above have various problems. For example, in the technique described in WO 2022/103599 A, metasurfaces are provided on both surfaces of a substrate, and thus, it is necessary to perform relative-position alignment of these metasurfaces, and also necessary to take advanced scratch countermeasures, and manufacturing is difficult. Further, in the technique described in US 2021/0275294 A, optical elements of the metalens, such as numerical aperture (NA), effective diameter, outer diameter, or the distance from the metasurface to a focal point, are not limited, and unwanted light such as ghost is likely to be generated; therefore, efficient focusing is difficult. Further, in JP 2024-12218 A, a collimation function of focusing collimated light is disclosed, but a function of tilting an outgoing-side optical axis with respect to an incident-side optical axis of the metasurface, or a function of focusing refracted outgoing light, is not sufficiently disclosed, and it may be difficult to achieve the desired focusing function.

One aspect of the present invention aims to provide a new technique in which refraction and focusing can be sufficiently implemented only by a metasurface formed on one principal surface of a substrate.

### SUMMARY OF THE INVENTION

In order to solve the above problems, a metalens according to one aspect of the present invention includes a metasurface that is configured by: a substrate which has an optical transparency at a main wavelength λ [nm]; and a plurality of pillars which are nano-sized, have the optical transparency, and are disposed on one principal surface of the substrate, wherein when a point of a phase maximum value of the metalens in an X direction is defined as a peak point, a position of the peak point in the X direction is defined as CM, a position of a boundary of a first annular zone following a continuous region which is maximum and includes the peak point in the X direction is defined as Xout1, the boundary being on a side opposite to an optical center of the metalens as viewed from the peak point, and a position of the boundary on an optical-center side of the metalens as viewed from the peak point is defined as Xin1, Formula (1) below is satisfied:

|Xout1−CM|>|Xin1−CM| (1).

In order to solve the above problems, a metalens according to one aspect of the present invention includes a metasurface that is configured by: a substrate which has an optical transparency at a main wavelength λ [nm]; and a plurality of pillars which are nano-sized, have the optical transparency, and are disposed on one principal surface of the substrate, wherein when an optical center of the metalens is defined as an origin, a direction in which a beam is tilted on the metalens from the origin is defined as a −X direction, a distance from the metalens to a focal point is defined as WD [μm], and an angle for tilting the beam in the −X direction is defined as Ang [deg], an aperture NA [μm] of the metalens satisfies Formula (3) below:

(0.012−0.0004×Ang)WD/(NA−1)<1.45 (3).

Further, in order to solve the above problems, an optical apparatus according to one aspect of the present invention includes the above-described metalens and a light source that irradiates the metalens with light.

In order to solve the above problems, a method for manufacturing a metalens according to one aspect of the present invention includes forming a metasurface by arranging pillars having an optical transparency on one principal surface of a substrate having the optical transparency at a main wavelength λ, such that, at the main wavelength λ [nm], a phase distribution of light transmitted through the metalens is obtained by adding a first phase distribution of the metasurface and a second phase distribution of the metasurface, wherein the first phase distribution of the metasurface is a phase distribution that converts an incident beam into light which is mainly more focused, and the second phase distribution of the metasurface is a phase distribution that converts a beam emitted from the metasurface into light which is mainly refracted in a direction away from an incident-side optical axis.

### Advantageous Effects of Invention

According to one aspect of the present invention, it is possible to provide a new technique in which refraction and focusing can be sufficiently implemented only by a metasurface formed on one principal surface of a substrate.

### BRIEF DESCRIPTION OF THE DRAWINGS

FIG. 1 is an external view of a metalens according to one embodiment of the present invention;

FIG. 2 is a diagram schematically showing a configuration of the metalens according to one embodiment of the present invention;

FIG. 3 is a diagram showing a height-direction reference of the metalens according to one embodiment of the present invention;

FIG. 4 is a diagram showing one example of a relationship between positions of pillars on an X-axis and a function S(x) in the metalens according to one embodiment of the present invention;

FIG. 5 is a diagram showing one example of an intensity distribution of outgoing light in an X-Z plane of the metalens according to one embodiment of the present invention;

FIG. 6 is a diagram showing one example of arrangement of pillars in the vicinity of a maximum continuous region including a peak point in the metalens according to one embodiment of the present invention;

FIG. 7 is a diagram showing one example of a two-dimensional distribution of an area of pillars of the metalens according to one embodiment of the present invention;

FIG. 8 is a diagram showing one example of a first phase distribution in an X direction in one embodiment of the present invention;

FIG. 9 is a diagram showing one example of a second phase distribution in the X direction in one embodiment of the present invention;

FIG. 10 is a diagram showing one example of a combined phase distribution in an X direction in one embodiment of the present invention;

FIG. 11 is a diagram showing one example of a distribution of base area of pillars converted from the combined phase distribution in one embodiment of the present invention;

FIG. 12 is a diagram schematically showing one example of a position of a rapid change (a wrap point) of the base area when pillars are arranged on a substrate in accordance with a distribution based on the base areas of the pillars;

FIG. 13 is a diagram schematically showing a first configuration example of an optical apparatus according to an embodiment of the present invention;

FIG. 14 is a diagram schematically showing a second configuration example of an optical apparatus according to an embodiment of the present invention;

FIG. 15 is a diagram showing a combined phase distribution of a metalens of Example 1;

FIG. 16 is a diagram showing a distribution of an area of pillars of the metalens of Example 1 in the X direction;

FIG. 17 is a diagram showing a two-dimensional distribution of an area of pillars of the metalens of Example 1;

FIG. 18 is a diagram showing arrangement of pillars of the metalens of Example 1;

FIG. 19 is a diagram showing an intensity distribution of outgoing light in an X-Z plane of an optical apparatus of Example 1;

FIG. 20 is a diagram showing an intensity distribution of outgoing light in an X-Y plane at a focal point of the optical apparatus of Example 1;

FIG. 21 is a diagram showing a two-dimensional distribution of an area of pillars in a metalens of Example 2;

FIG. 22 is a diagram showing arrangement of pillars in the metalens of Example 2;

FIG. 23 is a diagram showing an intensity distribution of outgoing light in an X-Z plane of an optical apparatus of Example 2;

FIG. 24 is a diagram showing an intensity distribution of outgoing light in an X-Y plane at a focal point of the optical apparatus of Example 2;

FIG. 25 is a diagram showing a distribution of an area of pillars of a metalens of Example 3 in the X direction;

FIG. 26 is a diagram showing a two-dimensional distribution of the area of pillars in the metalens of Example 3;

FIG. 27 is a diagram showing arrangement of pillars in the metalens of Example 3;

FIG. 28 is a diagram showing an intensity distribution of outgoing light in an X-Z plane of an optical apparatus of Example 3;

FIG. 29 is a diagram showing an intensity distribution of outgoing light in an X-Y plane at a focal point of the optical apparatus of Example 3;

FIG. 30 is a diagram showing a distribution of an area of pillars in a metalens of Example 4 in the X direction;

FIG. 31 is a diagram showing a two-dimensional distribution of the area of pillars in the metalens of Example 4;

FIG. 32 is a diagram showing arrangement of pillars in the metalens of Example 4;

FIG. 33 is a diagram showing an intensity distribution of outgoing light in an X-Z plane of an optical apparatus of Example 4;

FIG. 34 is a diagram showing an intensity distribution of outgoing light in an X-Y plane at a focal point of the optical apparatus of Example 4;

FIG. 35 is a diagram showing a distribution of an area of pillars of a metalens of Example 5 in the X direction;

FIG. 36 is a diagram showing a two-dimensional distribution of the area of pillars in the metalens of Example 5;

FIG. 37 is a diagram showing arrangement of pillars in the metalens of Example 5;

FIG. 38 is a diagram showing an intensity distribution of outgoing light in an X-Z plane of an optical apparatus of Example 5;

FIG. 39 is a diagram showing an intensity distribution of outgoing light in an X-Y plane at a focal point of the optical apparatus of Example 5;

FIG. 40 is a diagram showing an intensity distribution of outgoing light in an X-Z plane of an optical apparatus of Example 6; and

FIG. 41 is a diagram showing an intensity distribution of outgoing light in an X-Y plane at a focal point of the optical apparatus of Example 6.

### DESCRIPTION OF THE EMBODIMENTS

Hereinafter, embodiments of the present invention will be described.

### [Metalens]

### [Optical Configuration]

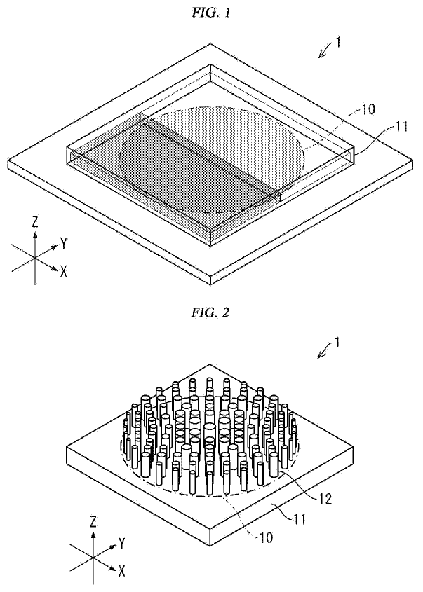

A metalens 1 according to an embodiment of the present invention has a metasurface 10, as shown in FIGS. 1 and 2. For example, the metasurface 10 is formed, on one principal surface of a substrate 11 whose shape in a plan view (planar shape) is a square, as a portion whose planar shape is a circle.

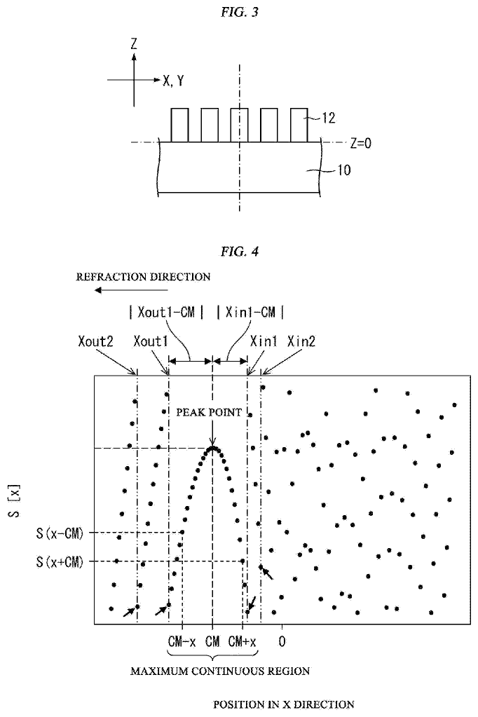

In the present embodiment, a direction of a side length of the planar shape of the substrate 11 is defined as an X direction, a direction orthogonal to the X direction in the planar shape is defined as a Y direction, and a thickness direction of the substrate 11 (a direction orthogonal to both the X direction and the Y direction) is defined as a Z direction. Further, in the present embodiment, as shown in FIG. 3, among positions in the Z direction of the metalens, a position on a base surface (an XY plane in the drawing) at an optical center of the metalens 1 or at a pillar 12 closest to the optical center of the metalens 1 is set as a zero point.

The metasurface 10 is a nanoscale-structure portion in the metalens 1, and is configured, for example, of the substrate 11 and a plurality of pillars 12. In the present description, terms including “nano”, such as “nanostructure”, “nanoparticle”, “nanomaterial”, and “nanopillar”, may include, for example, a structure having at least one dimension of 1000 nm or less, 900 nm or less, 800 nm or less, 700 nm or less, 600 nm or less, or 500 nm or less.

The substrate 11 is a plate-shaped member having an optical transparency at a main wavelength λ [nm]. The main wavelength λ [nm] may be, for example, a peak wavelength. In various embodiments, the incident light consists of light having a wavelength within an electromagnetic spectrum. In various embodiments, the incident light is, for example, light from visible light to near-infrared light having a wavelength of 300 nm to 3000 nm. The substrate 11 may have various shapes within a range having the above optical transparency. Further, the substrate 11 may be a flat plate, or may be a lens.

The pillars 12 are nanoscale structures that are formed of a material having an optical transparency at the main wavelength λ [nm] and are arranged in plurality on one principal surface of the substrate 11. Each of the pillars 12 is, for example, a nanoscale columnar body standing in the Z direction, and is a columnar body having a specific base shape.

The base shape of the pillars 12 may be, for example, circular, hexagonal, or quadrangular, and may be appropriately selected in accordance with desired characteristics. For example, since a circle is a shape that is symmetric with respect to any direction in a plan view, a pillar having a circular base shape exhibits uniform attenuation characteristics, whether in transmittance, electric-field characteristics, or polarization characteristics, in the direction of incident light from the light source. From applicability of Character Projection (CP), an octagonal-prism pillar or a hexagonal-prism pillar is also advantageous from the viewpoint of the above uniform attenuation characteristics, similarly to a cylindrical pillar. A square-prism pillar is advantageous from the viewpoint of efficiently obtaining a prism effect, and is advantageous from the viewpoint of exhibiting high wavelength resonance property and high transmittance characteristics.

The metalens 1 is not formed of an inorganic material in at least a major portion of the lens. For example, the metalens 1 contains no inorganic material in an amount of about 10 wt %, about 8 wt %, about 6 wt %, about 4 wt %, about 2 wt, or about 1 w %, or contains less than that amount. The inorganic material may include a metal (for example, Au or Al), and/or an oxide (for example, SiO₂ or TiO₂), and/or a semiconductor (for example, Si or GaN), and/or such materials, and/or combinations thereof.

A refractive index of the optically transparent material constituting the metalens 1 may be, for example, 1.7 or less, 1.6 or less, 1.5 or less, 1.48 or less, 1.46 or less, 1.44 or less, 1.42 or less, 1.40 or less, 1.38 or less, 1.36 or less, 1.35 or less, 1.34 or less, or 1.33 or less.

In addition, the thickness of the metalens 1 can be any one selected thickness, or a total thickness selected in plurality, of, for example, 1 micrometer to 1000 micrometers, 10 micrometers to 500 micrometers, 30 micrometers to 300 micrometers, 50 micrometers to 100 micrometers, 55 micrometers to 95 micrometers, 60 micrometers to 90 micrometers, 65 micrometers to 85 micrometers, 70 micrometers to 80 micrometers, or 75 micrometers.

In the metalens 1, unit cells are regularly set on one principal surface of the substrate 11. The unit cells are set in a checkerboard pattern. A side length of each unit cell of the checkerboard pattern may be, for example, 200 nm, 250 nm, 300 nm, 350 nm, 380 nm, 400 nm, 450 nm, 500 nm, 550 nm, 600 nm, 650 nm, 700 nm, 750 nm, 800 nm, 850 nm, 900 nm, or 950 nm. The pillars 12 are arranged in the unit cells, respectively. For example, the pillars 12 have different base areas depending on positions of the unit cells in which the pillars 12 are arranged, and have a constant height and a constant base shape (for example, a square) regardless of the positions of the unit cells. In this manner, the pillars 12 have the same base shape and the same height, and have different base areas depending on the positions of the unit cells.

### [Optical Characteristics]

The metalens 1 exhibits optical characteristics of deflecting and focusing light incident from another principal-surface side and emitting the light on one principal-surface side. From the viewpoint of exhibiting such optical characteristics, the metalens 1 preferably satisfies one or more of the formulas described below. In the following description, a direction in which the metalens 1 refracts light is the X direction. Further, an optical center of the metalens 1 is on an incident-side optical axis of the metalens 1, and a position (x, y) of the optical center in the X direction and the Y direction is (0, 0). A reference for a position in the Z direction is, as described above, a position at which one principal surface (an XY plane) of the substrate on which the pillars are arranged intersects the incident-side optical axis.

The metalens 1 preferably satisfies the following Formula (1).

|Xout1−CM|>|Xin1−CM| (1)

A peak point means a point of a maximum phase value of the metalens 1 in the X direction. Further, here, “CM” means a position of the peak point in the X direction. Further, “Xout1” means, among positions of a boundary of a first annular zone following a maximum continuous region including the peak point in the X direction, a boundary position on a side opposite to the optical center of the metalens as viewed from the peak point. In contrast, “Xin1” means, among the positions of the boundary of the first annular zone following the maximum continuous region including the peak point in the X direction, a boundary position on an optical-center side of the metalens as viewed from the peak point.

The “continuous region” is a region in which an area occupied by pillars per unit area changes continuously, and is surrounded by, or adjacent to, a region in which pillars whose area occupied by the pillars per unit area changes intermittently are distributed in a closed-curve shape or a band shape. The “positions of the boundary of the first annular zone following the continuous region” may be positions of outermost pillars, located at an outermost peripheral edge of the continuous region, in which the area occupied by the pillars per unit area changes continuously.

FIG. 4 shows one example of a relationship between positions of pillars and a peak point in an X-axis direction in the continuous region of the metalens of the present embodiment. In FIG. 4, the vertical axis represents a distribution of a phase folded into a range of 0 to 2π (a wrapped phase distribution), and a phase delay is represented as being positive.

In FIG. 4, the “maximum continuous region” is a region in which plots exist on an upwardly convex curve, and the “peak point” is a vertex of the curve. A direction in which light is deflected by the metalens 1 is a left side (a left side of the optical center x=0) with respect to a paper surface in the drawing, and the left side is defined as negative in the X direction.

In FIG. 4, “Xout1” is represented by a position of a pillar (indicated by a small arrow in the drawing) that is arranged, among pillars arranged in the continuous region, at a position close to the first annular zone on a − side, and “Xin1” is represented by a position of a pillar (indicated by a small arrow in the drawing) that is arranged, among the pillars arranged in the continuous region, at a position close to the first annular zone on a + side. “|Xout1−CM|” represents, in FIG. 4, a distance in the X direction between “Xout1” and the position of the peak point, and “|Xin1−CM|” represents, in FIG. 4, a distance in the X direction between “Xin1” and the position of the peak point.

Further, in FIG. 4, “Xout2” is represented by a position of a pillar (indicated by a small arrow in the drawing) that is arranged, among pillars arranged in the first annular zone, at a position close to a second annular zone on an outer side thereof on the − side, and “Xin2” is represented by a position of a pillar (indicated by a small arrow in the drawing) that is arranged, among the pillars arranged in the first annular zone, at a position close to the second annular zone on the outer side thereof on the + side.

Formula (1) defines that the metalens 1 includes the peak point. Thereby, Formula (1) indicates that the metalens 1 has a focusing function. Further, Formula (1) defines that a distance from the peak point to the boundary between the continuous region and the first annular zone on the − side in the X direction is larger than a distance from the peak point to the boundary between the continuous region and the first annular zone on the + side in the X direction. Thereby, Formula (1) indicates that the metalens 1 has a function of refracting light (also referred to as “prism function”). A larger difference between |Xout1−CM| and |Xin1−CM| is preferable from the viewpoint of enhancing the prism function.

The metalens 1 preferably satisfies the following Formula (2) in the continuous region including the peak point in the X direction when a direction from the optical center toward the peak point in the X direction is defined as a minus direction.

S(CM−x)−S(CM+x)>0 (2)

Here, “x” means an offset amount from the peak point toward an optical-center direction in the X direction. That is, an offset amount in a direction from the peak point toward the optical center is +x, and an offset amount in a direction from the peak point toward an outer side is-x. “S(x)” means a function of an area S occupied by the pillars 12 per unit area on one principal surface of the substrate 11. In the present description, “in the continuous region including the peak point in the X direction” means that both (CM−x) and (CM+x) are located within the continuous region.

FIG. 4 also shows one example of a relationship between a position of a pillar on the X-axis and the function S(x) in the metalens of the present embodiment. A direction in which light is deflected by the metalens 1 is a left side (the left side of the optical center x=0) with respect to a paper surface in the drawing, and when the left side is defined as negative in the X direction, positions shifted by x from CM to the − side or to the + side in the maximum continuous region are represented by “CM−x” and “CM+x”, respectively, in the drawing, and corresponding values of the function S are represented by “S(CM−x)” and “S(CM+x)”, respectively, in the drawing.

Formula (2) defines a relationship in the maximum continuous region including the peak point in the X direction. In this manner, Formula (2) defines that the metalens 1 includes the peak point, and thereby indicates that the metalens 1 has a focusing function.

Further, Formula (2) defines that an area S(CM−x) of the pillar 12 on the − side (outer side) by x from CM is larger than an area S(CM+x) of the pillar 12 on the + side (inner side) by x from CM, thereby indicating that the metalens 1 has a prism function.

S(CM−x)−S(CM+x) is preferably larger from the viewpoint of enhancing the prism function, and from such a viewpoint, S(CM−x)−S(CM+x) is more preferably 2 or more, still more preferably 3 or more, still more preferably 4 or more, and still more preferably 5 or more.

The metalens 1 may include pillars that do not satisfy Formula (2) within a range in which the above focusing function and prism function are exhibited. That is, the metalens 1 only needs to include, in the continuous region, a substantial number of pillars such that the pillars satisfy Formula (2) so that the above functions are exhibited, and not all pillars in the continuous region need to satisfy Formula (2).

Further, when the optical center of the metalens 1 is defined as an origin and a direction in which a beam is tilted on the metalens 1 from the origin is defined as a −X direction, the metalens 1 preferably has an aperture NA that satisfies the following Formula (3).

(0.012−0.0004×Ang)WD/(NA−1)<1.45 (3)

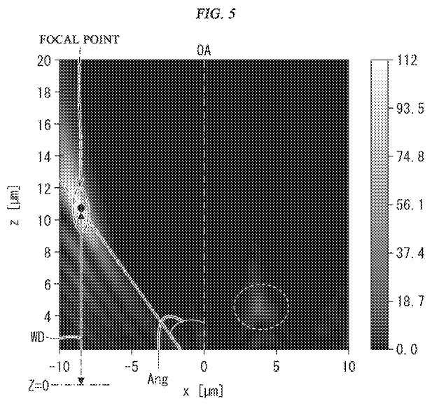

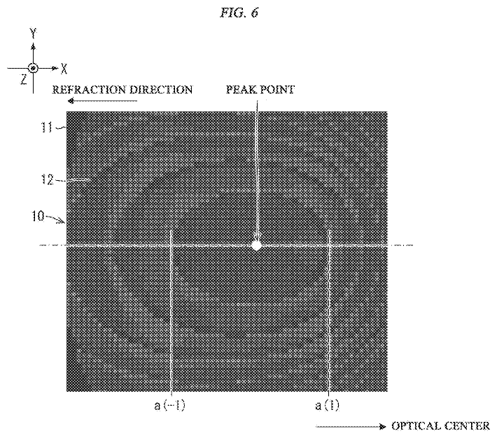

In Formula (3), “WD” means a distance [μm] from the metalens 1 to the focal point, and “Ang” means an angle [deg] for tilting a beam in the −X direction. FIG. 5 is a diagram showing one example of an intensity distribution of outgoing light in an X-Z plane of the metalens of the present embodiment. In FIG. 5, a straight line passing through x=0 and extending in the Z direction represents an incident-side optical axis OA of the metalens 1. Further, a line of z=0 is a straight line representing one principal surface of the substrate on which the pillars 12 are arranged. A diagonal dashed-dotted line in the drawing represents a traveling direction (outgoing-side optical axis) of light refracted by the prism function of the metalens 1, and the focal point exists on the optical axis. “WD” is represented by a distance in the Z direction from the line of z=0 to the focal point. Further, “Ang” is represented by an angle formed between the incident-side optical axis OA of the metalens 1 and the outgoing-side optical axis of the metalens 1.

In FIG. 5, the presence of outgoing light is also slightly observed in a positive region of x. This light is on a side substantially opposite to a refraction direction of light by the prism function, and is also referred to as “unwanted light” in the present embodiment.

Formula (3) defines a condition in which the prism function is sufficiently exhibited and generation of unwanted light is sufficiently suppressed. From the viewpoint of suppressing generation of unwanted light, (0.012−0.0004×Ang)WD/(NA−1) is preferably 1.4 or less, more preferably 1.3 or less, still more preferably 1.2 or less, still more preferably 1.1, still more preferably 1.0, still more preferably 0.9, still more preferably 0.8, still more preferably 0.7, still more preferably 0.6, and still more preferably 0.5. Further, (0.012−0.0004×Ang)WD/(NA−1) is preferably greater than 0, more preferably 0.1, still more preferably 0.2, and still more preferably 0.3.

Note that C can be set, for example, as a range in which unwanted light, obtained when a large number of samples are calculated while changing Ang in a range from 20 degrees to 60 degrees, can be sufficiently suppressed as compared with an intensity threshold thereof. In this manner, C can be appropriately determined in accordance with a magnitude of Ang and an intensity of the unwanted light, and can be appropriately determined in accordance with a use or required characteristics of the metalens 1. Ang may be within a specific range, and may be, for example, any one of ranges of 0 degrees to 5 degrees, 5 degrees to 10 degrees, 10 degrees to 20 degrees, 20 degrees to 30 degrees, 30 degrees to 40 degrees, 40 degrees to 50 degrees, 50 degrees to 60 degrees, 60 degrees to 70 degrees, and 70 degrees to 80 degrees, and may be a plurality of these ranges.

Further, the metalens 1 preferably satisfies the following Formula (4), where a derivative of the function S(x) is S′(x).

|S′(CM−x)|−|S′(CM+x)|<0.0 (4)

Formula (4) defines that a phase difference between the +X direction and the −X direction is negative. Formula (3) describes both the prism function and the focusing function. Further, since Formula (4) is represented by derivative of Formula (2), Formula (4) can indicate a condition for optimizing effectiveness of the phase difference. For example, when |S′(CM−x)|−|S′(CM+x)| is too large, phase wrapping may become fine and control by phase may become difficult, and when |S′(CM−x)|−|S′(CM+x)| is too small, effectiveness of control by phase may become small. From the viewpoint of sufficiently exhibiting both the focusing function and the prism function in the metalens 1, |S′(CM−x)|−|S′(CM+x)| is preferably smaller, and from such a viewpoint, |S′(CM−x)|−|S′(CM+x)| is preferably −1 or less, more preferably −2 or less, still more preferably −3 or less, still more preferably −4 or less, and still more preferably −5 or less.

Further, when a position at which the S rapidly changes on each of the + side and the − side of the peak point in the X direction is defined as a wrap point, the metalens 1 preferably satisfies the following Formula (5).

|a(−1)|−|a(1)|>0 (5)

The “wrap point”, that is, the “position at which S rapidly changes”, can represent a phase gap in a wrapped phase distribution. In Formula (5), “a(1)” means a position of the wrap point on the + side closest to the peak point in the X direction, and “a(−1)” means a position of the wrap point on the − side closest to the peak point in the X direction. Further, “a(n)” means a function that represents, by an order n, a distance from the peak point to the wrap point in the X direction. Note that “A” is the above-described main wavelength [nm].

FIG. 6 is a diagram showing one example of arrangement of pillars in the vicinity of the maximum continuous region including the peak point of the metalens of the present embodiment. In FIG. 6, the pillars 12 are shown as square dots, and the pillars 12 as a whole have sizes corresponding to magnitudes of the base areas. Further, a dashed-dotted line in the drawing represents the X-axis (y=0) in the metalens 1. In FIG. 6, boundaries of shades of the dots of the pillars 12 are along an elliptical-like curve. In FIG. 6, the peak point exists at a center portion of a smallest ellipse. The optical center of the metalens 1 is not shown in FIG. 6, and exists, for example, on an extension line of the dashed-dotted line in FIG. 6 on a right side of FIG. 6. Note that the dashed-dotted line is also a major axis of the smallest ellipse.

In FIG. 6, “a(−1)” is represented by an X-direction position of, among intersection points between the smallest ellipse and the dashed-dotted line described above, an intersection point on a light-refraction-direction side (left side), and “a(1)” is represented by an X-direction position of, among the intersection points between the smallest ellipse and the dashed-dotted line described above, an intersection point on an optical-center side (right side).

Formula (5) defines that the metalens 1 includes the peak point, and also defines that a position closest to the peak point at which S rapidly changes is biased to the + side, and therefore indicates that the metalens 1 has both the focusing function and the prism function. From the viewpoint of enhancing the prism effect, the bias is preferably larger, and from the viewpoint, |a(−1)|−|a(1)|/λ is preferably 0.3 or more, more preferably 0.5 or more, still more preferably 0.7 or more, still more preferably 0.8 or more, still more preferably 1.0 or more, still more preferably 1.2 or more, still more preferably 1.5 or more, still more preferably 1.8 or more, and still more preferably 2.0 or more.

Further, the metalens 1 preferably satisfies the following Formula (6) in the maximum continuous region including the peak point.

S2(CM−p,y)−S2(CM+p,y)>0 (6)

In Formula (6), “p” means an offset amount from the peak point in the X direction, “y” means an offset amount from the peak point in the Y direction, and “S2(x, y)” means a function of an area S2 occupied by pillars per unit area on one principal surface. Note that, as described above, the optical center of the metalens 1 is the origin, and the −X direction is a direction in which a beam is tilted on the metalens from the origin.

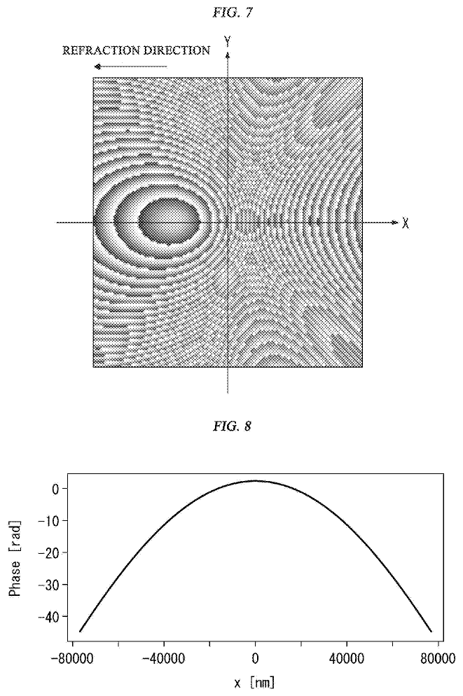

FIG. 7 is a diagram showing one example of a two-dimensional distribution of an area of pillars of the metalens 1 of the present embodiment. Formula (6) indicates that Formula (2) holds at an arbitrary position in the Y direction. A distribution of areas of the pillars 12 in the metalens 1 may have symmetry with respect to the X-axis in the Y direction. This configuration is suitable from the viewpoint of achieving compatibility between the focusing function and the prism function of the metalens 1. A degree of the symmetry may be completely symmetric in the Y direction with respect to the X-axis, or may be substantially symmetric to an extent that both the focusing function and the prism function are exhibited to a desired extent. For example, the symmetry may be such that, when, in Formula (2), x is replaced with the same “y” which is an offset amount in the Y direction between one side and the other side, a difference of the expression is zero, or may be within a range of an appropriate threshold (for example, within +0.5 or less).

S2(CM−p,y)−S2(CM+p,y) is preferably larger from the viewpoint of enhancing the prism function, and from the viewpoint, S2(CM−p,y)−S2(CM+p,y) is preferably 0.5 or more, more preferably 1.0 or more, still more preferably 2.0 or more, still more preferably 2.5 or more, still more preferably 3.0 or more, still more preferably 3.5 or more, still more preferably 4.0 or more, still more preferably 4.5 or more, still more preferably 5.0 or more, and still more preferably 5.5 or more.

Further, the metalens 1 preferably satisfies the following Formula (7).

1.5<nh/λ<6.5 (7)

In Formula (7), “n” means a refractive index of the metalens 1, and “h” means a height [μm] of the pillars 12, and therefore “nh” means an optical path length [μm] of the metalens 1. Note that “λ” is the above-described main wavelength [nm].

When nh/λ is too small, effectiveness by phase may be small, and when nh/λ is too large, a height relative to a base surface of a pillar becomes very long, thereby resulting in insufficient strength and difficulty in processability and making it impossible to exhibit an effect by phase in some cases. From the viewpoint of suppressing reduction in effectiveness by phase, nh/λ is preferably 1.7 or more, more preferably 1.9 or more, still more preferably 2.0 or more, still more preferably 2.1 or more, still more preferably 2.2 or more, and still more preferably 2.3 or more. Further, from the viewpoint of suppressing reduction in effectiveness by phase due to insufficient strength or the like, nh/λ is preferably 6.2 or less, more preferably 6.0 or less, still more preferably 5.8 or less, still more preferably 5.6 or less, still more preferably 5.4 or less, still more preferably 5.2, and still more preferably 5.1 or less.

Further, the metalens 1 preferably satisfies the following Formula (8). In Formula (8), F means the effective diameter [μm] of the metalens. “a(1)” and “a(−1)” are as described above with reference to FIG. 6.

0.05<(|a(−1)|−|a(1)|)/F<0.5 (8)

An effective diameter F of the metalens 1 represents a dimension of a region of the metalens 1 that is irradiated with incident light, and, when the region is circular, is the diameter of the region. The effective diameter F of the metalens 1 may be, for example, an outer diameter of a metasurface whose planar shape is circular. Alternatively, when only a part of the metasurface is irradiated with incident light, for example, when an aperture is arranged in the vicinity of the metalens 1 on an incident side of the metalens 1, the effective diameter F may be an aperture diameter of the aperture.

Formula (8) defines a ratio, with respect to the effective diameter of the metalens, of a size, in the refraction direction (X direction), of the smallest elliptical-like region including the peak point. When the region is too small, the focusing function may be insufficient, and when the region is too large, the prism function may be insufficient. From the viewpoint of sufficiently exhibiting the focusing function, (|a(−1)|−|a(1)|)/F is preferably 0.1 or more, more preferably 0.12 or more, still more preferably 0.14 or more, still more preferably 0.16 or more, and still more preferably 0.17 or more. From the viewpoint of sufficiently exhibiting the prism function, (|a(−1)|−|a(1)|)/F is preferably 0.45 or less, more preferably 0.40 or less, still more preferably 0.35 or less, still more preferably 0.30 or less, still more preferably 0.25, and still more preferably 0.2 or less.

Furthermore, as described above, in a case where the pillars 12 having base areas in accordance with positions on one principal surface of the substrate 11 are regularly arranged on the principal surface, the metalens 1 preferably satisfies the following Formula (9).

2.5<Smax/Smin<5.0 (9)

In Formula (9), “Smax” means a maximum base area [nm²] of the pillars 12, and “Smin” means a minimum base area [nm²] of the pillars 12.

From the viewpoint of sufficiently exhibiting the focusing function in the above aspect, Smax/Smin is preferably 2.7 or more, more preferably 2.9, still more preferably 3.0 or more, still more preferably 3.1 or more, still more preferably 3.25 or more, still more preferably 3.5 or more, and still more preferably 3.6 or more. Further, from the viewpoint of sufficiently exhibiting the prism function in the above aspect, Smax/Smin is preferably 4.5 or less, more preferably 4.3 or less, still more preferably 4.2 or less, still more preferably 4.1 or less, still more preferably 4.0 or less, still more preferably 3.9 or less, and still more preferably 3.8 or less.

### [Manufacturing Method of Metalens]

The metalens 1 can be manufactured by forming the metasurface 10 by arranging the pillars 12 having the optical transparency on one principal surface of the substrate 11 having the optical transparency at the main wavelength λ, such that, at the main wavelength λ [nm], a phase distribution of light transmitted through the metalens 1 is obtained by adding a first phase distribution of the metasurface 10 and a second phase distribution of the metasurface 10.

The first phase distribution of the metasurface 10 is a phase distribution that converts an incident beam into light that is mainly more focused. FIG. 8 is a diagram showing one example of the first phase distribution in the X direction according to the present embodiment. The first phase distribution can be represented, for example as shown in FIG. 8, by an upwardly convex curve having the optical center of the metalens 1 in the X direction as the peak point.

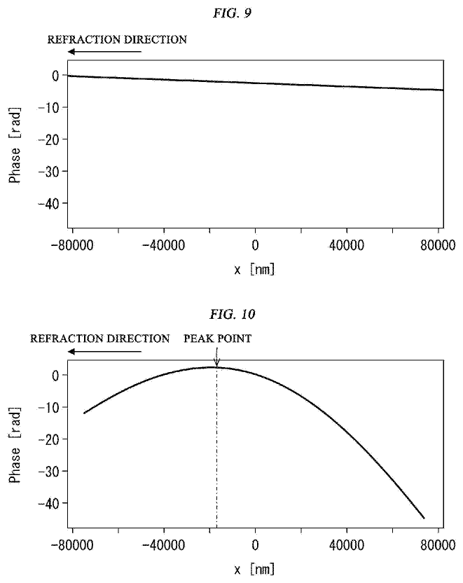

The second phase distribution of the metasurface 10 is a phase distribution that converts a beam emitted from the metasurface 10 into light that is mainly refracted in a direction away from the incident-side optical axis. FIG. 9 is a diagram showing one example of the second phase distribution in the X direction according to the present embodiment. The second phase distribution can be represented, for example as shown in FIG. 9, by a straight line that gradually increases from the +X direction toward an opposite side (−X direction) (that is, the refraction direction) in the X direction.

A phase distribution obtained by adding the first e distribution and the second phase distribution described above can exhibit both the focusing function by the first phase distribution and the prism function by the second phase distribution. FIG. 10 is a diagram showing one example of a phase distribution (also referred to as “combined phase distribution”) obtained by adding the first phase distribution and the second phase distribution in the X direction according to the present embodiment. The combined phase distribution can be represented, for example as shown in FIG. 10, by a biased-shaped curve in which the peak point of the curve of FIG. 8 is shifted in the increasing direction of the straight line of FIG. 9. In the curve of the combined phase distribution, the peak point is shifted from the optical center of the metalens 1 in the X direction toward the −X direction (refraction direction).

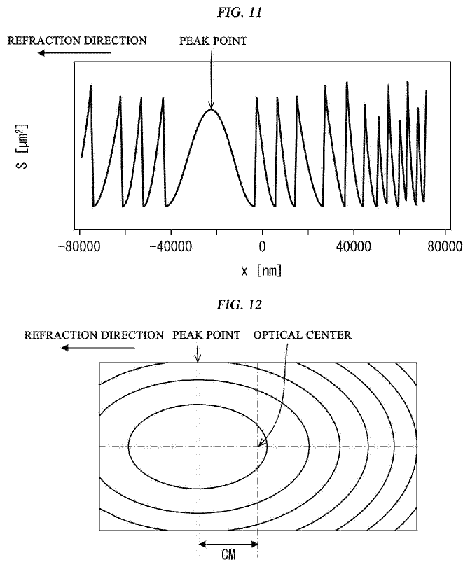

Next, the combined phase distribution is converted into a relationship of arrangement of the pillars 12. That is, the shape of the pillars 12 and the arrangement of the pillars 12 on one principal surface of the substrate 11 are specified, and information regarding the size of the pillars 12 is determined on the basis of a correlation relationship between the information regarding the size of the pillars 12 and a phase shift amount. Here, as described above, it is assumed that the combined phase distribution described above is implemented in the metasurface 10 by arranging, in each of regular lattice-like unit cells on one principal surface of the substrate 11, the pillars 12 having a constant height and the same shape and differing only in base area. FIG. 11 is a diagram showing one example of a distribution of base areas of pillars converted from the combined phase distribution according to the present embodiment. The distribution based on the base areas of the pillars 12 can be formed, for example as shown in FIG. 11, by the maximum continuous region represented by a series of convex curves including the peak point, and, on an outer side of the maximum continuous region, by a periodic repeating pattern that sharply increases and then more gently decreases.

Next, the pillars 12 each having a specific base area are arranged on the principal surface of the substrate 11 in accordance with the distribution based on the base areas of the pillars 12. FIG. 12 is a diagram schematically showing one example of a position of a rapid change (the above-described wrap point) of the base area when the pillars are arranged on the substrate in accordance with the distribution based on the base areas of the pillars. In FIG. 12, in order to explain a shift of the peak point and an influence of arrangement of pillars resulting from the shift, a distribution of the wrap points is shown in a simplified manner. The pillars 12 are arranged, for example as shown in FIG. 12, such that the wrap points are located at concentric elliptical positions having, as a center, the peak point shifted in the −X direction from the optical center and having the X direction as a major-axis direction. Note that a distance in the X direction between the optical center and the peak point is the above-described CM.

Next, the pillars 12 having the size of the determined information are arranged on one principal surface of the substrate 11 to form the metasurface 10. In the above manufacturing method, the above-described first phase distribution, second phase distribution, combined phase distribution, and distribution based on the base areas of the pillars can each be implemented by computer simulation using commercially available software for calculating such distributions. Further, the metalens 1 can be manufactured, on the basis of the above distribution of the pillars, using a known metasurface manufacturing technique.

In the above manufacturing method, the distribution of the pillars 12 satisfies at least one of the above-described Formulas (1) to (9). Therefore, the metalens 1 can be manufactured by designing arrangement of the pillars 12 so as to satisfy at least one of the above-described Formulas (1) to (9).

### [Optical Apparatus]

An optical apparatus of the present embodiment includes the above-described metalens of the present embodiment, and a light source that irradiates the metalens with light. The light source can be appropriately selected in accordance with a use of the optical apparatus. Examples of the light source include a laser having a radiation intensity with a Gaussian distribution, such an LED (light-emitting diode), a device that collimates and emits those, and a surface-emitting laser such as a VCSEL (vertical-cavity surface-emitting laser).

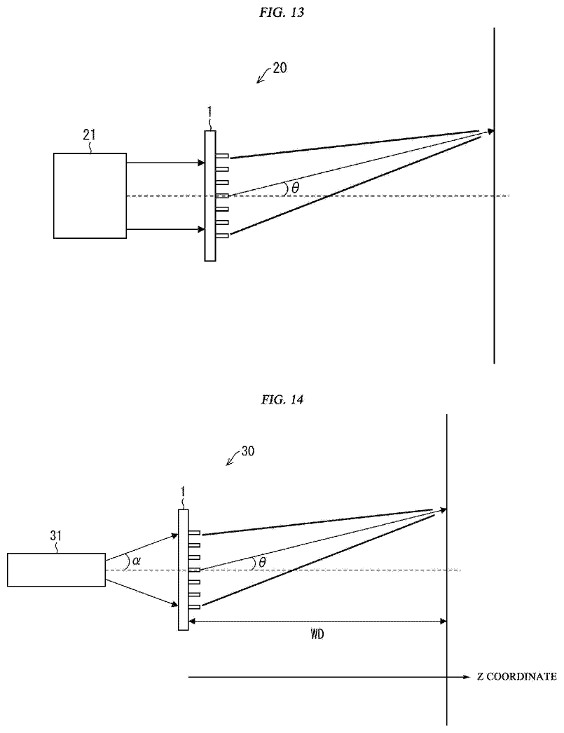

For example, as shown in FIG. 13, an optical apparatus 20 includes a light source 21 and the metalens 1. The light source 21 is a parallel-light source (collimated-light source) that irradiates the metalens 1 with collimated light from the other principal-surface side. Examples of the parallel-light source include a surface-emitting laser having a structure that emits light in a vertical direction, such as a VCSEL (vertical-cavity surface-emitting laser). The light source 21 irradiates the metalens 1 with collimated light from the other principal-surface side of the metalens 1. The collimated light is converted, by passing through the metasurface 10, into light that is refracted in a direction forming an angle θ with an optical axis on the incident side (collimated-light side) and that is focused at the focal point. “θ” can be represented by an angle formed by the outgoing-side optical axis with respect to the incident-side optical axis of the metalens 1, and is synonymous with the above-described “Ang”. In this manner, the optical apparatus 20 changes collimated light into a refracted focused beam.

In the present embodiment, the light source may be an apparatus that outputs collimated parallel light including, for example, an LED as described above, or may be a Gaussian-distribution light source. It is preferable that the light source is an apparatus that outputs light having a maximum center intensity, represented by a Gaussian beam, from the viewpoint of increasing versatility of the light source and enabling use of various light sources.

For example, as shown in FIG. 14, an optical apparatus 30 includes a light source 31 and the metalens 1. The light source 31 is an apparatus (Gaussian-light light source) that irradiates the metalens 1 with a Gaussian beam from the other principal-surface side. In FIG. 14, a divergence angle of the Gaussian beam incident on the metalens 1 is represented by a. The optical apparatus 30 changes the Gaussian beam into a refracted focused beam.

Note that a degree of focusing of outgoing light with respect to incident light can be appropriately adjusted by the above-described first phase distribution. Further, a degree of refraction of outgoing light with respect to incident light can be appropriately adjusted by the above-described second phase distribution.

In the optical apparatus of the present embodiment, e may be, for example, 0° to 45°, 0° to 20°, or 0° to 70°. More specifically, in the metalens 1, θ may be, for example, 0°, 5°, 10°, 20°, 30°, 40°, 50°, 60°, or 70°. The above e may be 12 degrees or more. A case where θ is a large angle as described above is advantageous from the viewpoint of easily achieving deviation from a straight light ray at a short distance.

Further, a larger θ is advantageous from the viewpoint of increasing a transmitted-light amount in the metalens 1. Further, a smaller θ is advantageous from the viewpoint of applying to countermeasures against linear zeroth-order light, which is general noise light in the metalens. From such viewpoints, θ is preferably 2.5 degrees or more, more preferably 3 degrees or more, still more preferably 4 degrees or more, still more preferably 5 degrees or more, still more preferably 6 degrees or more, still more preferably 7 degrees or more, still more preferably 8 degrees or more, still more preferably 9 degrees or more, and still more preferably 10 degrees or more. Further, from the above viewpoints, θ is preferably 25 degrees or less, more preferably 23 degrees or less, still more preferably 22 degrees or less, still more preferably 21 degrees or less, still more preferably 20 degrees or less, still more preferably 18 degrees or less, still more preferably 16 degrees or less, still more preferably 14 degrees or less, still more preferably 12 degrees or less, and still more preferably 10 degrees or less.

Further, in the optical apparatus of the present embodiment, from the above-described viewpoint of versatility and from the viewpoint of implementing sufficient focusing of outgoing light, x may be 2 degrees or more or may be greater than 2 degrees, and, on the other hand, may be less than 28 degrees or may be 20 degrees or less.

The optical apparatus of the present embodiment may further include other optical elements in addition to the above-described light source and metalens, within a range in which the effects of the present invention can be obtained. For example, the optical apparatus may include another lens other than the above-described metalens. The other lens is an optical lens, and may be a complex lens. Further, the optical apparatus of the present embodiment may further include an aperture arranged close to the incident side (the other principal-surface side) of the metalens 1 from the viewpoint of making an effective diameter of the metalens 1 smaller than an outer diameter of the metasurface.

### Applications

Since the metalens of the present embodiment can be miniaturized, the metalens can be applied to an application of tilting a beam that has passed through a fiber in an oblique direction in a fiber-output optical system. Further, an aspect in which a refraction angle (the above-described Ang or θ) of outgoing light from the metalens is greater than 20 degrees can be applied to, for example, acquisition of scattered light having an angle, such as in a Raman probe. On the other hand, in an aspect in which the refraction angle of outgoing light from the metalens is small, i.e., 20 degrees or less, the metalens can be applied to countermeasures against zeroth-order noise light while maintaining illuminance efficiency.

As an application of a small fiber-output optical system, the metalens is expected to be applied, particularly in a Raman probe used for caries diagnosis, to an ultraminiature metalens optical-system apparatus having a function of forming an image in an oblique direction from an incident-side optical axis. The metalens of the present embodiment, which simultaneously has the function of tilting a source beam and the focusing function, is expected to be applied to various applications other than the above, in which both the focusing function and the prism function are expected.

### OTHER EMBODIMENTS

As described above, in the metalens of the present embodiment, the shape of pillar may be a polygonal column other than a quadrangular column, or may be a circular column.

Further, the metalens of the present embodiment may be configured by arranging pillars of a single shape at a density in accordance with the combined phase distribution. Such arrangement of pillars can also be specified by computer simulation using the above-described commercially available software.

Further, regular unit cells set on the substrate may be configured in a pattern other than a lattice pattern, and may be, for example, a hexagonal grid in which hexagonal unit cells are arranged in a closest-packed manner.

Further, although the metalens 1 of the above-described embodiment is a focusing lens (convex lens), the metalens 1 may be a concave lens.

Further, in the present invention, one or both of the substrate and the pillars may be made of a biomaterial. Such an aspect is suitable from the viewpoint of implementing a metalens that responds to changes in an environment (such as pH, temperature, ion concentration, light, an electrical signal, an electric field, a magnetic field, biomolecular interaction (antibody-antigen binding, aptamer binding, etc.), solution concentration, humidity, hydration, and presence of a chemical substance) by changing optical characteristics or light modulation characteristics.

Further, in the above-described embodiment, light from the light source is incident on the metalens from the other principal-surface side of the substrate (a principal surface on a side opposite to the metasurface), but light from the light source may be incident from a metasurface side. For example, in the aspect of FIG. 13, refracted collimated light can be emitted by irradiating the metalens 1 with a Gaussian beam from the metasurface side, and in the aspect of FIG. 14, a refracted focused beam can be emitted by irradiating the metalens 1 with a Gaussian beam from the metasurface side.

### SUMMARY

According to a first aspect of the present invention, a metalens (1) includes a metasurface (10) that is configured by: a substrate (11) which has an optical transparency at a main wavelength λ [nm]; and a plurality of pillars (12) which are nano-sized, have the optical transparency, and are disposed on one principal surface of the substrate, wherein when a point of a phase maximum value of the metalens in an X direction is defined as a peak point, a position of the peak point in the X direction is defined as CM, a position of a boundary of a first annular zone following a continuous region which is maximum and includes the peak point in the X direction is defined as Xout1, the boundary being on a side opposite to an optical center of the metalens as viewed from the peak point, and a position of the boundary on an optical-center side of the metalens as viewed from the peak point is defined as Xin1, the above-described Formula (1) is satisfied. According to the first aspect, it is possible to provide a new technique in which refraction and focusing can be sufficiently implemented only by a metasurface formed on one principal surface of a substrate.

According to a second aspect of the present invention, in the first aspect, when, in the X direction, a direction from the optical center toward the peak point is defined as a minus direction, an offset amount from the peak point toward the optical center in the X direction is defined as x, and an area S occupied by the pillars per unit area on the one principal surface is defined as a function S(x), the above-described Formula (2) is satisfied in a continuous region including the peak point in the X direction. The second aspect is even more effective from the viewpoint of adjusting the prism function.

According to a third aspect of the present invention, in the first aspect or the second aspect, when the optical center of the metalens is defined as an origin, a direction in which a beam is tilted on the metalens from the origin is defined as a −X direction, a distance from the metalens to a focal point is defined as WD [μm], and an angle for tilting the beam in the −X direction is defined as Ang [deg], an aperture NA of the metalens satisfies the above-described Formula (3). The third aspect is even more effective from the viewpoint of sufficiently suppressing generation of unwanted light.

According to a fourth aspect of the present invention, in the second aspect, when a derivative of the function S(x) is defined as S′(x), the above-described Formula (4) is satisfied. The fourth aspect is even more effective from the viewpoint of sufficiently enabling refraction and focusing to be implemented by the metasurface formed only on one principal surface of a substrate.

According to a fifth aspect of the present invention, in the second aspect or the fourth aspect, when positions at which the area S rapidly changes respectively on a + side and a + side of the peak point in the X direction are defined as wrap points, a position of the wrap points on the + side closest to the peak point in the X direction is defined as a(1), a position of the wrap points on the − side closest to the peak point in the X direction is defined as a(−1), and a function representing a distance from the peak point to one of the wrap points in the X direction by an order n is expressed as a(n), the above-described Formula (5) is satisfied. The fifth aspect is even more effective from the viewpoint of sufficiently enabling refraction and focusing to be implemented by the metasurface formed only on one principal surface of a substrate.

According to a sixth aspect of the present invention, in any one of the second aspect, the fourth aspect, and the fifth aspect, when the optical center of the metalens is defined as an origin, a direction in which a beam is tilted on the metalens from the origin is defined as a −X direction, an offset amount from the peak point in the X direction is defined as p, an offset amount from the peak point in a Y direction orthogonal to the X direction along the one principal surface is defined as y, and an area S2 occupied by the pillars per unit area on the one principal surface is defined as a function S2(x, y), the above-described Formula (6) is satisfied in the continuous region which is maximum and includes the peak point. The sixth aspect is even more effective from the viewpoint of sufficiently enabling refraction and focusing to be implemented by the metasurface formed only on one principal surface of a substrate.

According to a seventh aspect of the present invention, in any one of the first to sixth aspects, when a refractive index of the metalens is defined as n and a height of the pillars is defined as h [μm], an optical path length nh [μm] of the metalens satisfies the above-described Formula (7). The seventh aspect is even more effective from the viewpoint of increasing effectiveness by phase.

According to an eighth aspect of the present invention, in any one of the second aspect, the fourth aspect, the fifth aspect, and the sixth aspect, when a direction in which a beam is tilted on the metalens from the origin is defined as a −X direction, positions at which the area S rapidly changes respectively on a + side and a + side of the peak point in the X direction are defined as wrap points, a position of the wrap points on the + side closest to the peak point in the X direction is defined as a(1), a position of the wrap points on the − side closest to the peak point in the X direction is defined as a(−1), and an effective diameter of the metalens is defined as F [μm], the above-described Formula (8) is satisfied. The eighth aspect is even more effective from the viewpoint of appropriately exhibiting the functions of refraction and focusing.

According to a ninth aspect of the present invention, in any one of the first to eighth aspects, the pillars are respectively arranged in unit cells that are regularly set on the one principal surface, and the pillars have the same base shape and the same height and have base areas that differ depending on positions of the unit cells. The ninth aspect is even more effective from the viewpoint of making it easier to arrange the pillars to exhibit a desired function in the metalens.

According to a tenth aspect of the present invention, in the ninth aspect, when a maximum base area of the pillars is defined as Smax and a minimum base area of the pillars is defined as Smin, the above-described Formula (9) is satisfied. The tenth aspect is even more effective from the viewpoint of making it easier to arrange the pillars to exhibit a desired function in the metalens, and from the viewpoint of appropriately exhibiting the functions of refraction and focusing.

According to an eleventh aspect of the present invention, a metalens includes a metasurface that is configured by: a substrate which has an optical transparency at a main wavelength λ [nm]; and a plurality of pillars which are nano-sized, have the optical transparency, and are disposed on one principal surface of the substrate, wherein when an optical center of the metalens is defined as an origin, a direction in which a beam is tilted on the metalens from the origin is defined as a −X direction, a distance from the metalens to a focal point is defined as WD [μm], and an angle for tilting the beam in the −X direction is defined as Ang [deg], an aperture NA [μm] of the metalens satisfies the above-described Formula (3). According to the eleventh aspect, it is possible to provide a new technique in which refraction and focusing can be sufficiently implemented only by a metasurface formed on one principal surface of a substrate.

According to a twelfth aspect of the present invention, an optical apparatus includes: the metalens of any one of the first to eleventh aspects; and a light source that irradiates the metalens with light. According to the twelfth aspect, it is possible to provide a new technique in which refraction and focusing can be sufficiently implemented only by a metasurface formed on one principal surface of a substrate.

According to a thirteenth aspect of the present invention, in the twelfth aspect, the light source is a parallel-light light source. The thirteenth aspect is advantageous for increasing an aperture diameter of the metalens or increasing an NA of light, and is even more effective from the viewpoint of relaxing positional accuracy in an optical-axis direction on an incident side of the metalens, because a spherical-lens effect of the metalens can be reduced as compared with a case where a light-source luminous flux is a diffused light source.

According to a fourteenth aspect of the present invention, a method for manufacturing a metalens includes forming a metasurface by arranging pillars having an optical transparency on one principal surface of a substrate having the optical transparency at a main wavelength λ, such that, at the main wavelength λ [nm], a phase distribution of light transmitted through the metalens is obtained by adding a first phase distribution of the metasurface and a second phase distribution of the metasurface, wherein the first phase distribution of the metasurface is a phase distribution that converts an incident beam into light which is mainly more focused, and the second phase distribution of the metasurface is a phase distribution that converts a beam emitted from the metasurface into light which is mainly refracted in a direction away from an incident-side optical axis. According to the fourteenth aspect, it is possible to provide a new technique in which refraction and focusing can be sufficiently implemented only by a metasurface formed on one principal surface of a substrate.

According to a fifteenth aspect of the present invention, in the fourteenth aspect, a shape of the pillars and an arrangement of the pillars on the one principal surface are specified, and information regarding a size of the pillars is determined based on a correlation relationship between the information regarding the size of the pillars and a phase shift amount, and the pillars having the size of the information which has been determined are arranged on the one principal surface to form the metasurface. The fifteenth aspect is even more effective from the viewpoint of making it easier to arrange the pillars to exhibit a desired function in the metalens.

As is apparent from the above description, in the present invention, by adding, to a conventional metalens that does not tilt a beam, a phase distribution having a prism effect, a metalens having, together with a focusing function, a function of tilting a beam in an oblique direction with respect to an incident-side optical axis is provided, and miniaturization of an optical element having such a function is implemented. In the present invention, since the above functions are achieved only by the metasurface on one principal surface of the metalens, manufacture becomes easier, in that alignment between a front surface and a rear surface becomes unnecessary and in that handling or management becomes easy, as compared with a metalens having metasurfaces on respective ones of two principal surfaces, i.e., one principal surface and the other principal surface.

Thus, according to one aspect of the present invention, it is possible to provide a metalens that can be tilted while having a function of focusing or a function of diverging after focusing, by means of a nanostructure only on one principal surface of a substrate. The present invention, which achieves such effects, is expected to contribute, for example, to the achievement of Sustainable Development Goal (SDG) 9 proposed by the United Nations, namely “build resilient infrastructure, promote sustainable industrialization and foster innovation”.

The present invention is not limited to the above-described embodiments, and various modifications are possible within a scope recited in the claims. Embodiments obtained appropriately combining technical means disclosed in respective different embodiments are also included in the technical scope of the present invention.

### EXAMPLES

### Example 1

According to the following specifications, a metalens of Example 1 that refracts and focuses collimated light was designed by forming, on one principal surface of the following substrate, a metasurface by an arrangement of the following pillars. A planar shape of the substrate is a square, and a planar shape of the metasurface is a circle.

### [Design Specifications]

### (1) Substrate

Material: SiO₂
Form of unit cells: lattice pattern
Period of unit cells: 380 nm

### (2) Pillars

Material: a-Si—H (N=3.8)
Shape: quadrangular column having a square base shape
Height: 480 nm

### (3) Metasurface

Outer diameter: 50 μm

### (4) Metalens

f: 10 μm
NA: 0.93
Prism angle: 45 degrees
Focusing distance BF: 10 μm
Minimum wrap diameter/outer diameter: 0.228
Base-area change of pillars: 3.65

The “period of unit cells” in the substrate is a center-to-center distance between adjacent unit cells. The “N” of the material of the pillars is a refractive index at a wavelength used. The “outer diameter” of the metasurface is an effective diameter of the metalens in the example. The “f” of the metalens is a focal length (WD) at the wavelength used. The “prism angle” of the metalens is an angle formed by the outgoing-side optical axis with respect to the incident-side optical axis, and is the above-described “e” and “Ang”. The “minimum wrap diameter” of the metalens is a distance (|a(−1)|−|a(1)|) between the above-described a(1) and a(−1) in the X direction. The “base-area change of pillars” of the metalens is obtained by a square of a ratio of the maximum base area Smax to the minimum base area Smin of the pillars in the metasurface.

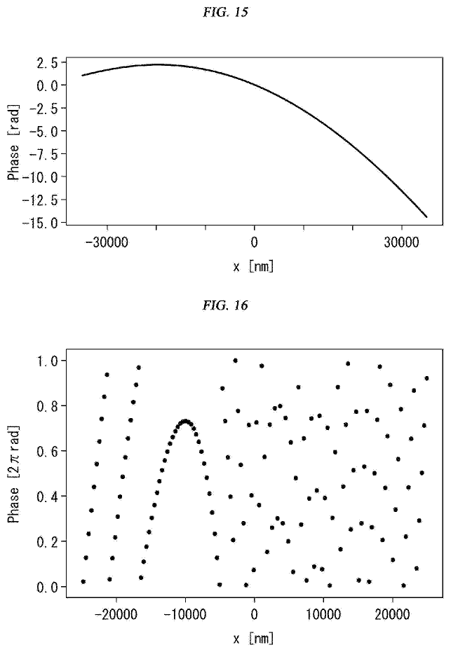

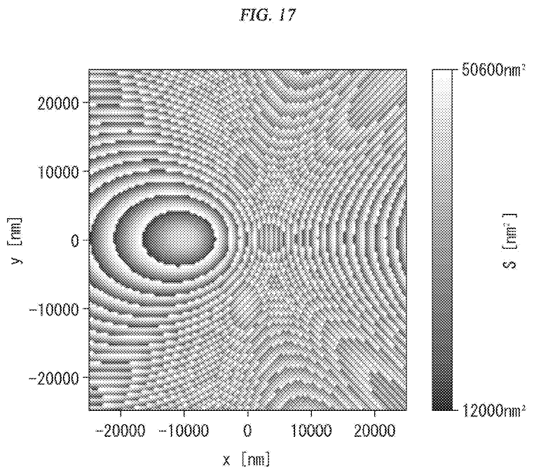

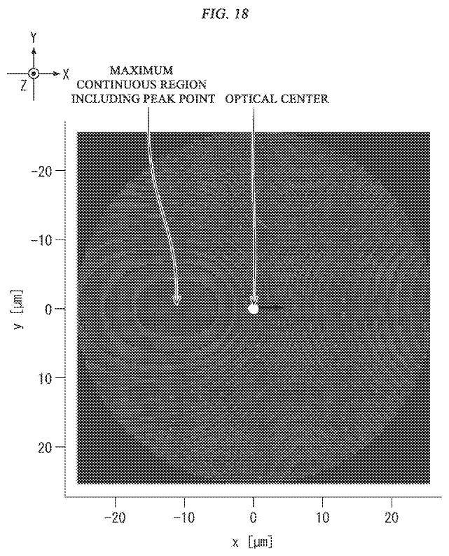

A combined phase distribution of the metalens of Example 1 is shown in FIG. 15, a distribution of areas of the pillars in the X direction is shown in FIG. 16, a two-dimensional distribution of the areas of the pillars is shown in FIG. 17, and an arrangement of the pillars is shown in FIG. 18. In FIG. 16, a length of one side of a base surface in the X direction is linked to a phase of the pillars. In FIG. 16, this phase is visualized.

An optical apparatus of Example 1 as shown in FIG. 13 was configured using the metalens of Example 1. A light source in the optical apparatus of Example 1 is a parallel-light source that outputs collimated light whose main wavelength is 785 nm. In Example 1, a ratio of the period of unit cells to the main wavelength is 0.484.

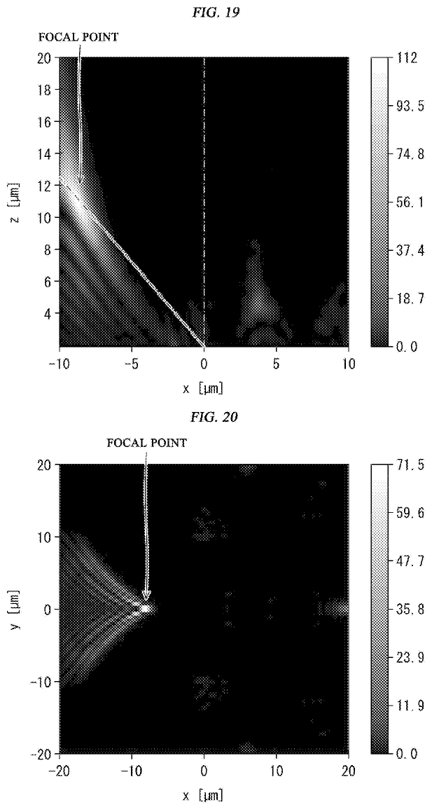

An intensity distribution of outgoing light in an X-Z plane of the optical apparatus of Example 1 is shown in FIG. 19, and an intensity distribution of outgoing light in an X-Y plane at a focal point of Example 1 is shown in FIG. 20. In Example 1, the meta-lens and the optical apparatus emit the incident collimated light so as to refract it at an angle of 45 degrees and focus it.

### Example 2

By changing the specifications from those of Example 1 in the following respects, a metalens of Example 2 was designed in which a metasurface is formed, on one principal surface of a substrate, by arranging pillars as described below to refract and focus a Gaussian beam.

### [Design Specifications]

### (3) Metasurface

Outer diameter: 80 μm

### (4) Metalens

f: 100 μm
NA: 0.89
Focusing distance BF: 100 μm
Minimum wrap diameter/outer diameter: 0.18

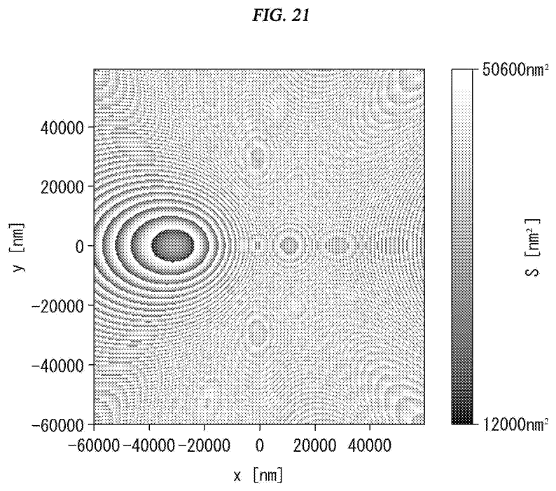

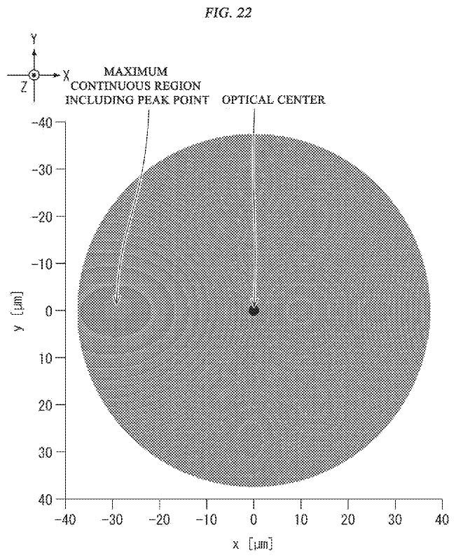

Regarding Example 2, a distribution of areas of pillars in the X direction of the metalens is shown in FIG. 21, a two-dimensional distribution of the areas of the pillars is shown in FIG. 21, and an arrangement of the pillars is shown in FIG. 22.

An optical apparatus of Example 2 as shown in FIG. 14 was configured using the metalens of Example 2. A light source in the optical apparatus of Example 2 is a Gaussian-light source that outputs Gaussian light whose main wavelength is 785 nm. Specifications of the light source are as follows.

### [Specifications of Light Source]

α: 53 degrees
NA of Gaussian light source: 0.8
Distance from an exit pupil of the light source to the metalens of Example 2:44.4 μm

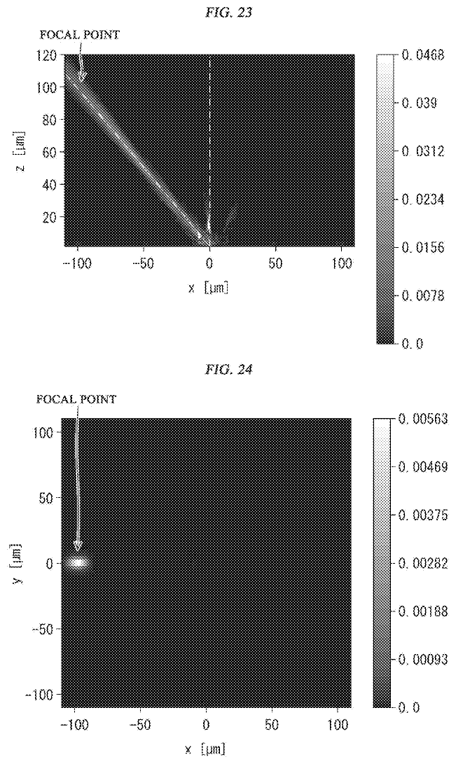

An intensity distribution of outgoing light in an X-Z plane of the optical apparatus of Example 2 is shown in FIG. 23, and an intensity distribution of outgoing light in an X-Y plane at a focal point of Example 2 is shown in FIG. 24. In Example 2, the meta-lens and the optical apparatus emit the incident Gaussian light so as to refract it at an angle of 45 degrees and focus it.

### Example 3

By changing the specifications from those of Example 1 in the following respects, a metalens of Example 3 was designed in which collimated light is refracted and focused.

### [Design Specifications]

### (3) Metasurface

Outer diameter: 60 μm

### (4) Metalens

f: 100 μm
NA: 0.30 Prism angle: 10 degrees
Focusing distance BF: 100 μm
Minimum wrap diameter/outer diameter: 0.20

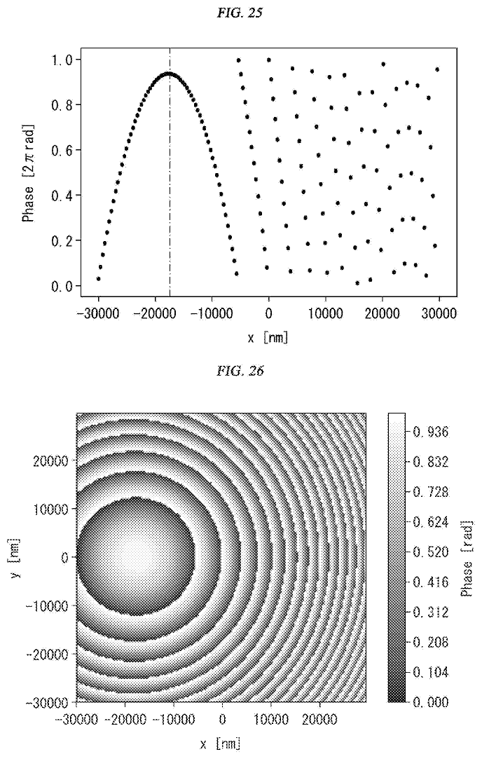

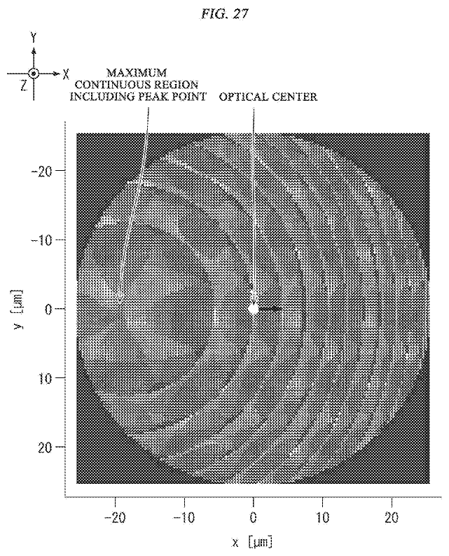

Regarding Example 3, a distribution of areas of pillars in the X direction of the metalens is shown in FIG. 25, a two-dimensional distribution of the areas of the pillars is shown in FIG. 26, and an arrangement of the pillars is shown in FIG. 27. Note that FIG. 27 is a drawing obtained by cutting out a portion corresponding to an effective diameter of 50 μm from a metalens having an outer diameter (effective diameter) of 60 μm, and is not a drawing showing any particular difference in design.

An optical apparatus of Example 3 as shown in FIG. 13 was configured using the metalens of Example 3. A light source in the optical apparatus of Example 3 is a parallel-light source that outputs collimated light whose main wavelength is 785 nm.

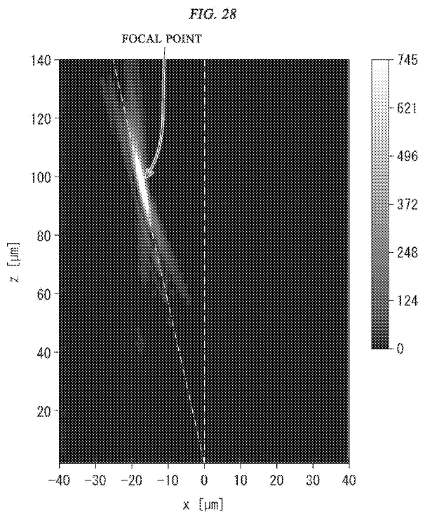

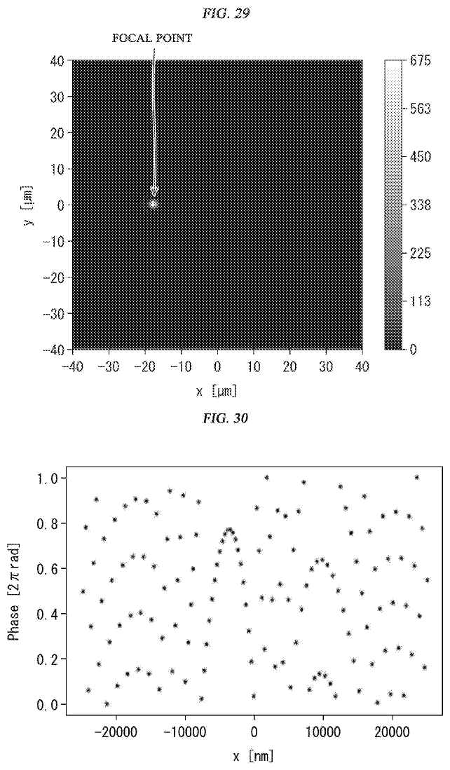

An intensity distribution of outgoing light in an X-Z plane of the optical apparatus of Example 3 is shown in FIG. 28, and an intensity distribution of outgoing light in an X-Y plane at a focal point of Example 3 is shown in FIG. 29. In Example 3, the meta-lens and the optical apparatus emit the incident collimated light so as to refract it at an angle of 10 degrees and focus it.

### Example 4

By changing the specifications from those of Example 1 in the following respects, a metalens of Example 4 was designed in which collimated light is refracted and focused.

### [Design Specifications]

### (4) Metalens

Prism angle: 20 degrees
Minimum wrap diameter/outer diameter: 0.16

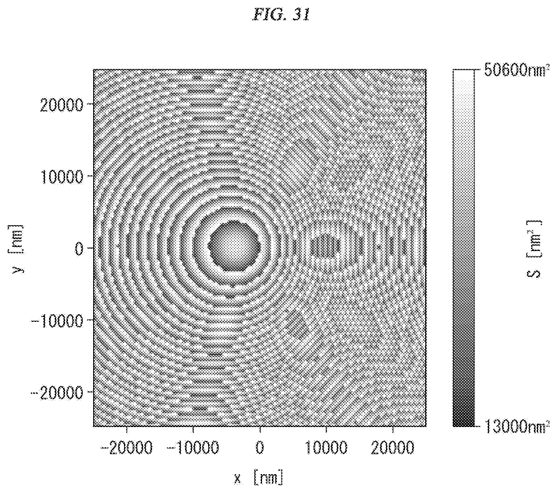

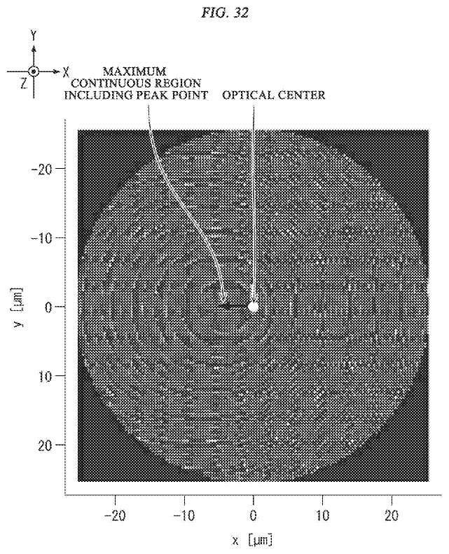

Regarding Example 4, a distribution of areas of pillars in the X direction of the metalens is shown in FIG. 30, a two-dimensional distribution of the areas of the pillars is shown in FIG. 31, and an arrangement of the pillars is shown in FIG. 32.

An optical apparatus of Example 4 as shown in FIG. 13 was configured using the metalens of Example 4. A light source in the optical apparatus of Example 4 is a parallel-light source that outputs collimated light whose main wavelength is 785 nm.

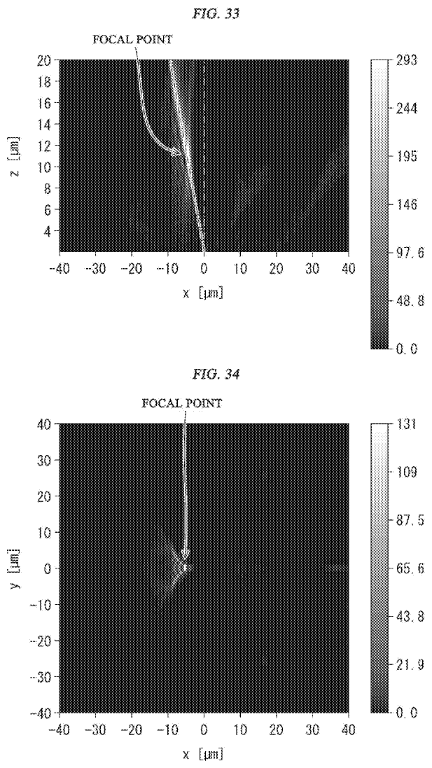

An intensity distribution of outgoing light in an X-Z plane of the optical apparatus of Example 4 is shown in FIG. 33, and an intensity distribution of outgoing light in an X-Y plane at a focal point of Example 4 is shown in FIG. 34. In Example 4, the meta-lens and the optical apparatus emit the incident collimated light so as to refract it at an angle of 20 degrees and focus it.

### Example 5

By changing the specifications from those of Example 1 in the following respects, a metalens of Example 5 was designed in which collimated light is refracted and focused.

### [Design Specifications]

### (1) Substrate

Period of unit cells: 300 nm

### (2) Pillars

Material: TiO₂ (N=2.54)
Height: 900 nm

### (4) Metalens

NA: 0.148
Prism angle: 10 degrees
focusing distance BF: 100 μm
Minimum wrap diameter/outer diameter: 0.24
Base-area change of pillars: 3.75

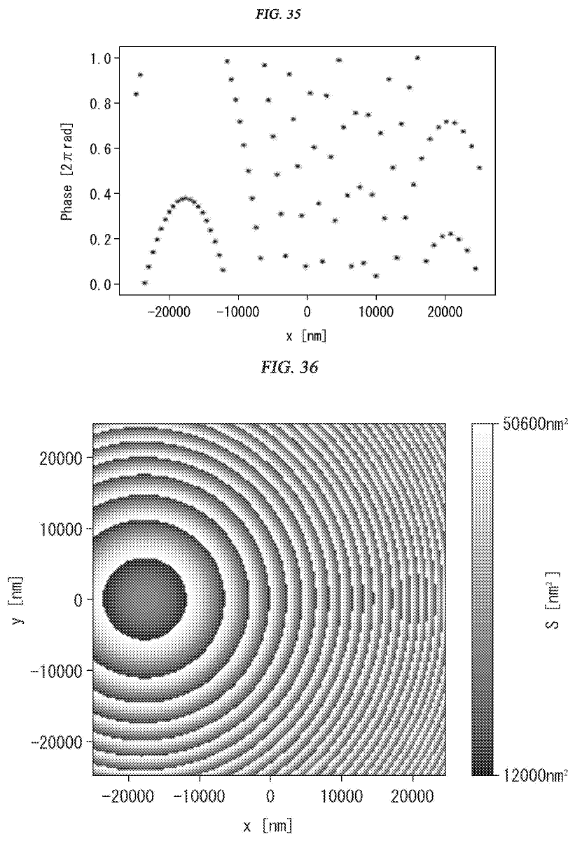

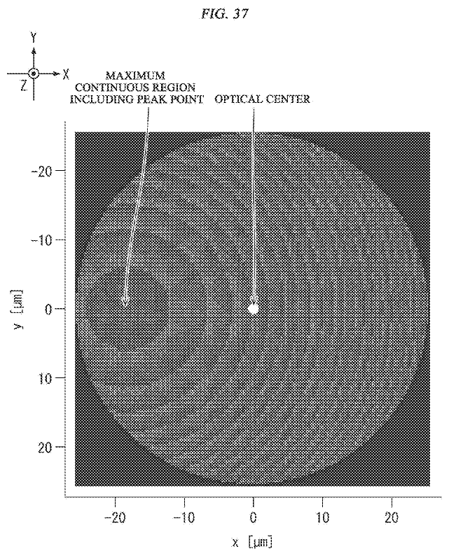

Regarding Example 5, a distribution of areas of pillars in the X direction of the metalens is shown in FIG. 35, a two-dimensional distribution of the areas of the pillars is shown in FIG. 36, and an arrangement of the pillars is shown in FIG. 37.

An optical apparatus of Example 5 as shown in FIG. 13 was configured using the metalens of Example 5. A light source in the optical apparatus of Example 5 is a parallel-light source that outputs collimated light whose main wavelength is 450 nm. In Example 5, a ratio of the period of unit cells to the main wavelength is 0.66.

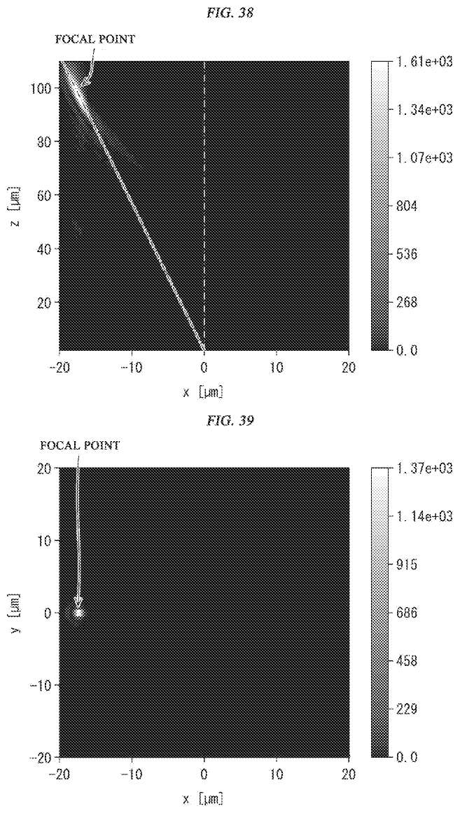

An intensity distribution of outgoing light in an X-Z plane of the optical apparatus of Example 5 is shown in FIG. 38, and an intensity distribution of outgoing light in an X-Y plane at a focal point of Example 5 is shown in FIG. 39. In Example 5, the meta-lens and the optical apparatus emit the incident collimated light so as to refract it at an angle of 10 degrees and focus it.

### Example 6

According to the following specifications, a metalens of Example 6 that refracts and focuses collimated light was designed by forming, on one principal surface of the substrate, a metasurface.

### [Design Specifications]

### (1) Substrate

Material: SiO₂
Form of unit cells: lattice pattern
Period of unit cells: 380 nm

### (2) Pillars

Material: a-Si—H (N=3.8)
Shape: quadrangular column having a square base shape
Height: 480 nm

### (3) Metasurface

Outer diameter: 50 μm

### (4) Metalens

f: 5 μm
NA: 0.98
Prism angle: 45 degrees
Focusing distance BF: 5 μm
Minimum wrap diameter/outer diameter: 0.228
Base-area change of pillars: 3.65

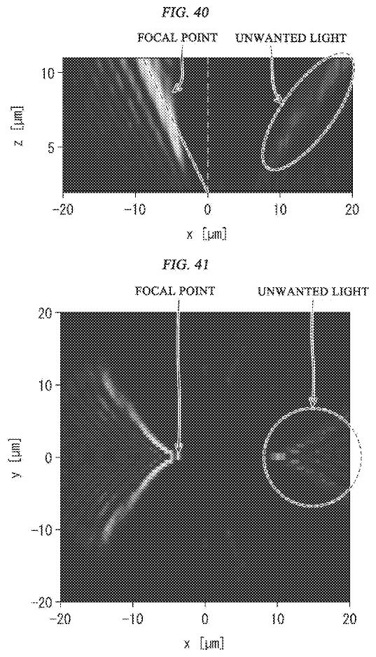

An intensity distribution of outgoing light in an X-Z plane of the optical apparatus of Example 6 is shown in FIG. 40, and an intensity distribution of outgoing light in an X-Y plane at a focal point of Example 6 is shown in FIG. 41. In the reference example, the meta-lens and the optical apparatus emit the incident collimated light so as to refract it at an angle of 10 degrees and focus it. It is also understood that light is emitted also on a side opposite to the outgoing light in the X direction.

For Examples 1 to 6, a ratio (unwanted light/normal light) of a maximum value of intensity of unwanted light to a maximum value of intensity of normal light of the metalens was obtained. The unwanted light is light that is deflected and emitted toward a side opposite to a deflecting direction due to the prism function of the metalens in the X direction.

As a result, the maximum intensity ratio (unwanted light/normal light) was 0.3 in Example 1, 0.05 or less in Examples 2, 4, and 5, and 0.2 in Example 3. In contrast, the maximum intensity ratio was as high as 0.36 in Example 6.

Numerical values of the above-described Formulas (1) to (9) in Examples 1 to 5 are shown in Table 1 below. In the table below, units of numerical values of Formula (1) and Formula (5) are μm, and units of numerical values of Formula (2) and Formula (6) are μm². Further, “e±n” in Formulas (2) and (4) indicates “×10^{±n}”.

TABLE 1

| | | Example 1 | Example 2 | Example 3 |
|---|---|---|---|---|
| (1) | \| Xout1 − CM \| | 10.99 | 13.35 | 26.69 |
| | \| Xin1 − CM \| | 9.42 | 10.20 | 24.33 |
| (2) | (S (CM − x) − S (CM + x)) | 0.48e4 | 0.48e4 | 1.52e4 |
| (3) | (0.012 − 0.0004 × Ang) WD/(NA − 1) | 0.84 | 1.24 | −0.56 |
| (4) | \| S′ (CM − x) \| − \| S′ (CM + x) \| | 5.5e−7 | 5.5e−7 | 5.5e−7 |
| (5) | \| a (−1) \| − \| a (1) \| | 1.93 | 1.69 | 0.97 |
| (6) | S2 (CM − p, y) − S2 (CM + p, y) | 0.48e4 | 0.48e4 | 1.52e4 |
| (7) | nh/λ | 2.32 | 2.32 | 2.32 |
| (8) | (a (−1) − a (1))/F | 0.288 | 0.18 | 0.20 |
| (9) | Smax/Smin | 3.65 | 3.65 | 3.65 |

| | | Example 4 | Example 5 |
|---|---|---|---|
| (1) | \| Xout1 − CM \| | 8.64 | 7.85 |
| | \| Xin1 − CM \| | 7.07 | 7.07 |
| (2) | (S (CM − x) − S (CM + x)) | 0.39e4 | 0.10e4 |
| (3) | (0.012 − 0.0004 × Ang) WD/(NA − 1) | −0.56 | −0.47 |
| (4) | \| S′ (CM − x) \| − \| S′ (CM + x) \| | 5.5e−7 | 7.3e−4 |
| (5) | \| a (−1) \| − \| a (1) \| | 0.48 | 0.66 |
| (6) | S2 (CM + p, y) − S2 (CM − p, y) | 0.39e4 | 0.10e4 |
| (7) | nh/λ | 2.32 | 5.08 |
| (8) | (a (−1) − a (1))/F | 0.16 | 0.24 |
| (9) | Smax/Smin | 3.65 | 2.56 |

Further, numerical data other than those described above in Examples 1 to 5 are shown in Table 2 below. Units of the numerical values in Table 2 are all μm.

TABLE 2

| | Exam- | Exam- | Exam- | Exam- | Exam- |
|---|---|---|---|---|---|
| | ple 1 | ple 2 | ple 3 | ple 4 | ple 5 |
| CM | 10 | 10 | 17 | 4 | 17.5 |
| λ | 0.785 | 0.785 | 0.785 | 0.785 | 0.450 |
| \| Xout2 − CM \| | 24.34 | 22.76 | — | 13.15 | — |
| \| Xin2 − CM \| | 13.34 | 14.13 | — | 10.21 | — |

Further, Table 3 below shows the numbers of pillars up to the continuous region and the first annular zone in Examples 1 to 5.

TABLE 3
Number of pillars from CM

| | Example 1 | Example 2 | Example 3 | Example 4 | Example 5 |
|---|---|---|---|---|---|
| To Xout1 | 14 | 17 | 34 | 11 | 10 |
| To Xin1 | 12 | 13 | 31 | 9 | 9 |
| To Xout2 | 31 | 29 | — | 17 | — |
| To Xin2 | 17 | 18 | — | 13 | — |

1. A metalens comprising:
a metasurface that is configured by: a substrate which has an optical transparency at a main wavelength λ [nm]; and a plurality of pillars which are nano-sized, have the optical transparency, and are disposed on one principal surface of the substrate, wherein
when a point of a phase maximum value of the metalens in an X direction is defined as a peak point,
a position of the peak point in the X direction is defined as CM,
a position of a boundary of a first annular zone following a continuous region which is maximum and includes the peak point in the X direction is defined as Xout1, the boundary being on a side opposite to an optical center of the metalens as viewed from the peak point, and
a position of the boundary on an optical-center side of the metalens as viewed from the peak point is defined as Xin1,
Formula (1) below is satisfied:

|Xout1−CM|>|Xin1−CM| (1).

2. The metalens according to claim 1, wherein
when, in the X direction, a direction from the optical center toward the peak point is defined as a minus direction,
an offset amount from the peak point toward the optical center in the X direction is defined as x, and
an area S occupied by the pillars per unit area on the one principal surface is defined as a function S(x),
Formula (2) below is satisfied in a continuous region including the peak point in the X direction:
S(CM−x)−S(CM+x)>0 (2).

3. The metalens according to claim 1, wherein
when the optical center of the metalens is defined as an origin,
a direction in which a beam is tilted on the metalens from the origin is defined as a −X direction,
a distance from the metalens to a focal point is defined as WD [μm], and
an angle for tilting the beam in the −X direction is defined as Ang [deg],
an aperture NA of the metalens satisfies Formula (3) below:
(0.012−0.0004×Ang)WD/(NA−1)<1.45 (3).

4. The metalens according to claim 2, wherein
when a derivative of the function S(x) is defined as S′(x), Formula (4) below is satisfied:

|S′(CM−x)|−|S′(CM+x)|<0.0 (4).

5. The metalens according to claim 2, wherein
when positions at which the area S rapidly changes respectively on a + side and a − side of the peak point in the X direction are defined as wrap points,
a position of the wrap points on the + side closest to the peak point in the X direction is defined as a(1),
a position of the wrap points on the − side closest to the peak point in the X direction is defined as a(−1), and
a function representing a distance from the peak point to one of the wrap points in the X direction by an order n is expressed as a(n),
Formula (5) below is satisfied:

|a(−1)|−|a(1)|>0 (5).

6. The metalens according to claim 4, wherein
when the optical center of the metalens is defined as an origin,
a direction in which a beam is tilted on the metalens from the origin is defined as a −X direction,
an offset amount from the peak point in the X direction is defined as p,
an offset amount from the peak point in a Y direction orthogonal to the X direction along the one principal surface is defined as y, and
an area S2 occupied by the pillars per unit area on the one principal surface is defined as a function S2(x, y),
Formula (6) below is satisfied in the continuous region which is maximum and includes the peak point:
S2(CM−p,y)−S2(CM+p,y)>0 (6).

7. The metalens according to claim 1, wherein
when a refractive index of the metalens is defined as n and a height of the pillars is defined as h [μm],
an optical path length nh [μm] of the metalens satisfies Formula (7) below:
1.5<nh/λ<6.5 (7).

8. The metalens according to claim 2, wherein
when the optical center of the metalens is defined as an origin,
a direction in which a beam is tilted on the metalens from the origin is defined as a −X direction,
positions at which the area S rapidly changes respectively on a + side and a + side of the peak point in the X direction are defined as wrap points,
a position of the wrap points on the + side closest to the peak point in the X direction is defined as a(1),
a position of the wrap points on the − side closest to the peak point in the X direction is defined as a(−1), and
an effective diameter of the metalens is defined as F [μm],
Formula (8) below is satisfied:
0.05<(|a(−1)|−|a(1)|)/F<0.5 (8).

9. The metalens according to claim 1, wherein
the pillars are respectively arranged in unit cells that are regularly set on the one principal surface, and
the pillars have the same base shape and the same height and have base areas that differ depending on positions of the unit cells.

10. The metalens according to claim 8, wherein
when a maximum base area of the pillars is defined as Smax and a minimum base area of the pillars is defined as Smin,
Formula (9) below is satisfied:
2.5<Smax/Smin<5.0 (9).

11. A metalens comprising:
a metasurface that is configured by: a substrate which has an optical transparency at a main wavelength λ [nm]; and a plurality of pillars which are nano-sized, have the optical transparency, and are disposed on one principal surface of the substrate, wherein
when an optical center of the metalens is defined as an origin,
a direction in which a beam is tilted on the metalens from the origin is defined as a −X direction,
a distance from the metalens to a focal point is defined as WD [μm], and
an angle for tilting the beam in the −X direction is defined as Ang [deg],
an aperture NA [μm] of the metalens satisfies Formula (3) below:
(0.012−0.0004×Ang)WD/(NA−1)<1.45 (3).

12. An optical apparatus comprising:
the metalens according to claim 1; and
a light source that irradiates the metalens with light.

13. The optical apparatus according to claim 12, wherein
the light source is a parallel-light light source.

14. A method for manufacturing a metalens, the method comprising:
forming a metasurface by arranging pillars having an optical transparency on one principal surface of a substrate having the optical transparency at a main wavelength λ, such that, at the main wavelength λ [nm], a phase distribution of light transmitted through the metalens is obtained by adding a first phase distribution of the metasurface and a second phase distribution of the metasurface, wherein
the first phase distribution of the metasurface is a phase distribution that converts an incident beam into light which is mainly more focused, and
the second phase distribution of the metasurface is a phase distribution that converts a beam emitted from the metasurface into light which is mainly refracted in a direction away from an incident-side optical axis.

15. The method according to claim 14, wherein
a shape of the pillars and an arrangement of the pillars on the one principal surface are specified, and
information regarding a size of the pillars is determined based on a correlation relationship between the information regarding the size of the pillars and a phase shift amount, and the pillars having the size of the information which has been determined are arranged on the one principal surface to form the metasurface.
